(19) United States
(12) Patent Application Publication
(10) Pub. No.: US 2014/0156341 A1
(43) Pub. Date: Jun. 5, 2014

(54) IDENTIFYING POTENTIAL CUSTOMERS USING SOCIAL NETWORKS

(71) Applicant: Sebastian Ryszard Kruk, Gdansk (PL)

(72) Inventor: Sebastian Ryszard Kruk, Gdansk (PL)

(73) Assignee: CoreSystems AG, Windisch (CH)

(21) Appl. No.: 13/705,806

(22) Filed: Dec. 5, 2012

(51) Int. Cl. G06Q 50/00

(52) U.S. Cl. CPC G06Q 50/01; G06Q 30/0201
USPC 705/7.29

(57) ABSTRACT

Embodiments are directed to a method for operating at least one computing device to identify potential customers. The method includes analyzing social media content to determine a need of a social media user. A business that can meet the determined need is identified. The method notifies the identified business that the social media user may be a potential customer. Some embodiments are directed to a computer device comprising a processor adapted to perform the above method. Other embodiments are directed to at least one non-transitory computer-readable storage medium comprising computer-executable instructions that, when executed, perform the above method.

### BACKGROUND OF INVENTION

Online social networks enable users of a social media platform to communicate with one another both publicly and privately. Users may communicate with friends, strangers and businesses. For example, many businesses have Twitter and Facebook accounts that enable the businesses to interact with their customers and/or potential customers. Businesses may use social networks to advertise products, services, or promotions and/or respond to users' questions and complaints.

Advertisements on a social media platform may be targeted to particular users based on the users' activities on the social media platform. The advertisements are generally created in advance and displayed to hundreds or thousands of users.

Businesses also use customer relationship management (CRM) software to manage clients and potential customers. Marketing teams may use CRM software to track leads and communications with potential customers over a time frame of weeks, months and years.

Both advertising campaigns and potential customer lead management using CRM software is relatively slow and does not allow a business to react in real time to a potential customer's needs.

### BRIEF SUMMARY OF INVENTION

The inventor has recognized and appreciated that there is a significant benefit that arises from reacting to a potential customer's expressed need in real time, in particular when the potential customer is making a purchasing decision, making a complaint, expressing a problem with a product or a service, and/or looking for advice regarding a product and/or service.

Accordingly, in some aspects, embodiments of the invention relate to a method of operating at least one computing device. The method may include analyzing social media content to determine a need of a social media user. A business that can meet the determined need may be identified. The method may include notifying the identified business that the social media user may be a potential customer. In some embodiments, notifying the identified business may entail sending contact information for the potential customer to a mobile device associated with the identified business. An operator of that mobile device may then initiate real time, human contact with the potential customer.

Some embodiments relate to at least one computing device for identifying potential customers. The at least one computing device may include at least one network interface adapted to receive social media content from a social media platform. The at least one computing device may include a storage device adapted to store information about a plurality of businesses. The at least one computing device may further include a processor adapted to execute a method. The method may include analyzing social media content to determine a need of a social media user. The method may include identifying a business that can meet the determined need. The at least one network interface may be further adapted to notify the identified business that the social media user may be a potential customer.

Some embodiments related to at least one non-transitory computer-readable storage medium comprising computer-executable instructions that, when executed, perform a method for identifying potential customers. The method may include analyzing social media content to determine a need of a social media user. A business that can meet the determined need may be identified. The method may include notifying the identified business that the social media user may be a potential customer.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a simplified block diagram of a computing environment of some embodiments;

FIG. 2 is a flow diagram of an identification process for identifying potential customers for one or more businesses;

FIG. 3 is a flow diagram of an analysis process for analyzing a user's social media content to determine at least one need of the user;

FIG. 4 is a flow diagram of an identification process for identifying a business that can meet the need of a social media user; and

FIG. 5 is a simplified block diagram of an exemplary computing device of some embodiments.

### DETAILED DESCRIPTION OF INVENTION

The inventor has recognized and appreciated that there is a significant benefit that arises from reacting to a potential customer's expressed need in real time, in particular when the potential customer is making a purchasing decision or might otherwise be receptive to information about a particular item, such as a product or service. By identifying a social media user's need in real time, a human employee of a business can send a message to the identified social media user while the user is in the process of making a purchasing decision thereby influencing the social media user to make a purchase or otherwise select a product or service from the business.

The inventor has further recognized and appreciated that many smaller businesses cannot afford and/or have no need for the expensive enterprise resource planning (ERP) software that is used by many larger companies, which often requires a dedicated server for executing the ERP software. Smaller companies may benefit from a cloud-based service that allows the business to use certain useful aspects of ERP software, such as customer relationship management (CRM) software, without paying for other portions of the software and without the need for installing and maintaining the ERP software on a server owned by the business.

By offering ERP as software as a service (SaaS), the entity operating the ERP software in the cloud may perform unique processes that would not be performed on ERP software running on a server dedicated to a single business. The ERP SaaS may perform tasks for multiple businesses simultaneously. For example, the CRM portion of the ERP software may help multiple businesses manage and track clients and potential leads.

The inventor has recognized and appreciated that social media content may be used to generate leads (i.e., potential customers). The process of analyzing social media content to identify potential leads may be performed more efficiently by the ERP SaaS provider than if an independent analysis was performed by each business executing its own ERP software. For example, the initial steps of analyzing social media content may be independent of the business and, therefore, if each business performed the steps, work would be duplicated. Thus, it may be more efficient for a third party server, independent from each individual business of a plurality of businesses, to perform the analysis and transmit information about users of a social media platform that may be potential customers of a particular business to that particular business.

Moreover, the inventor has recognized and appreciated that a small number of parameters of social media messages provide a reliable indication of needs. These parameters may be quickly extracted from the social media content and used for matching needs to business profiles. In this way, prospective customers for specific businesses may be identified quickly enough to allow the business to contact the prospective customer while the expression of need is still fresh for the user. Such real-time contact may provide significant value for both a business and a user of a social media platform.

By way of example, some embodiments may analyze social media content from a social media platform, such as Twitter or Facebook. In the case of Twitter, the social media content may be tweets, posted by one or more users of Twitter. In the case of Facebook, the social media content may be status updates, notes, or any other messages sent based on any suitable activity performed by one or more users of Facebook. In some embodiments, only activity that is posted with global visibility is analyzed. Embodiments of the invention are not limited to any particular social media platform. For example, some embodiments may analyze social media content from Google+ or LinkedIn. In some embodiments, websites that host user generated content, but are not social networking websites, may be analyzed. Examples of such sites include, but are not limited to Craigslist, Yelp and/or Reddit.In some embodiments, users may explicitly post their needs to a portal associated with the service provider. The service provider may then analyze the posted needs in a similar way needs extracted from social media content are analyzed.

Some embodiments may filter the social media content to isolate the content that appears to express a need of the user. For example, in the case of Twitter tweets, some embodiments may filter the available tweets down to 1% of the total number of available tweets. Filtering may be used to remove tweets determined to be spam, remove tweets from certain specified users, or remove tweets that contain specified keywords (such as curse words). Though, to reduce the total number of available tweets to a desired level, one or more filtering criteria may alternatively or additionally be applied.

In some embodiments, the filtered social media content may be analyzed to determine a need of the social media platform user. For example, a tweet from a user may state, “Oh no! My water heater broke.” The tweet may be analyzed in any suitable way to determine that the user is in need of a water heater and/or a plumber. The tweet may also be analyzed to determine a location and a sentiment of the user. This may be done based on the tweet itself, the user's social media platform profile, or the tweet history of the user.

Some embodiments transmit the determined need, location and sentiment of the tweet to a system, which may contain at least one processor, that will compare at least the need, the location and the sentiment to a business profile previously received by businesses that are clients of the third party ERP SaaS provider. For example, a business profile may specify key words related to the types of service and products that the business provides. The business profile may also include information about the service area or delivery area for which the business provides service for customers. For example, a plumber may only be interested in customers that are within a certain area, such as within 20 miles of the location of the business. The information in the business profile may be input into a system specifically for identifying potential customers using social media content. Alternatively or additionally, the business profile may contain information derived from other sources, including information otherwise maintained by an ERP SaaS provider.

Some embodiments provide a personalized message to the social media user. Such a message may be created by a human, such as an employee of a business that can meet the need. Accordingly, transmitting the determined need may include sending a communication to a portable electronic device operated by a human that will provide a personalized response. Though, any suitable technologies, including automated processing, may be used to create a personalized response. By creating a personalized message, the social media user may feel a personal connection to the business and be more likely to consider purchasing a product and/or service from the business.

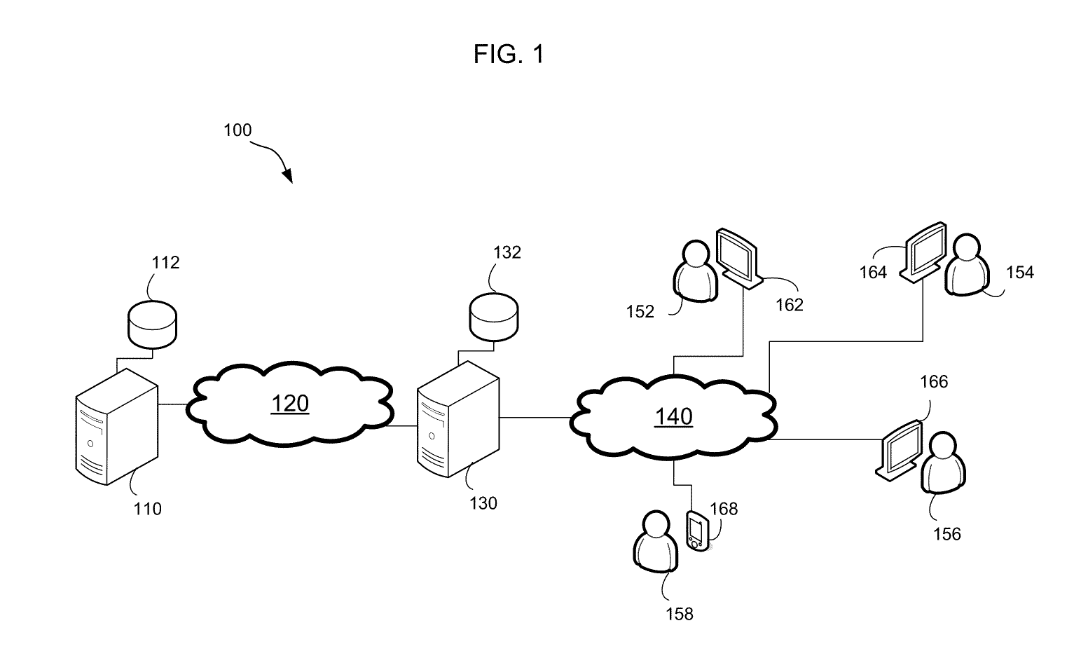

FIG. 1 illustrates an exemplary computing environment 100 in accordance with some embodiments. In this example, at least one social media platform server 110 is operated by a company that provides a social media platform for users to form a social network. The at least one server 110 communicates with at least one database 112. The at least one database 112 stores information about users of the social media platform. For example, the at least one database 112 may store user profiles that include a nickname, a real name, an email address, a physical address, a city, a state, a county, and/or a phone number for each user of the social media platform. The at least one database 112 may also store social media content associated with each user of the social media platform. In the example were the company operating the server 110 and the database 112 is Twitter, the social media content may include one or more tweets received from the user in any suitable way. For example, the user may tweet from a mobile telephone or a computer.

In some embodiments, the at least one database 112 may be included as part of the at least one server 110. In other embodiments, the at least one database 112 and the at least one server 110 are separate and communicate over, for example, an intranet or any other suitable network. Embodiments are not limited to any particular social media platform architecture.

Computing environment 100 includes at least one ERP server 130. In the embodiment shown in FIG. 1, the at least one ERP server is operated by a third party other than the operator of the social media platform and the businesses that use the ERP service. However, embodiments of the invention are not so limited. The at least one ERP server 130 may be, for example, operated by the social media company or by one of the businesses that uses the ERP service. Also, in some embodiments, the server 130 may not be an ERP server that provides all ERP services. For example, server 130 may be a CRM server or a server dedicated to providing customer leads to businesses.

Server 130 communicates with at least one database 132. Database 132 stores profile information for the plurality of businesses that subscribe to the ERP service. In some embodiments, database 132 may be included as part of the at least one ERP server 130. In other embodiments, the at least one database 132 and the at least one server 130 are separate and communicate over, for example, an intranet or any other suitable network. Embodiments are not limited to any particular ERP architecture.

In some embodiments, database 132 may also store historical information about potential customers. For example, if a user's need is determined at a first time based on at least one portion of social media content, that need may be stored for future use at a second time. At a second time, the server 130 may determine an additional need of the user based on at least a second portion of social media content. The relevance of the second need may be increased or decreased by the first need or any other need that was previously determined for the social media platform user or other users of the social media platform.

In this way, in some embodiments, the at least one ERP server 130 may build a profile for one or more of the social media platform users. The profile may include any suitable information about the users. A profile may include, for example, historical needs of the user (as determined by server 130), times/dates when needs were expressed by the user, geolocation information about the user, and flags that indicate the user is a spammer or some other undesirable user type.

The at least one ERP server 130 receives social media content from the at least one social media platform server 110 via network 120. Network 120 may be, for example, the Internet and servers 110 and 130 may communicate over network 120 using at least one network interface. The received social media content may be pre-filtered by the social media platform server 110 prior to transmission over network 120 or the at least one ERP server 130, or any other suitable device, may perform filtering of the social media content. If the social media platform server 110 performs filtering of the social media content prior to transmission, then the filtering may be done in response to filtering information provided to the social media platform server 110 by ERP server 130. Any suitable filtering criteria may be used to filter the social media content. For example, filtering may be used to remove content determined to be spam, remove content associated with a set of specified users, or remove tweets that contain specified keywords, such as curse words or any other undesirable words.

The at least one ERP server 130 analyzes the received social media content to determine at least one need of the social media platform user. The analysis of the social media content may be done in any suitable way. In some embodiments, natural language processing may be used to extract at least one need of the user from the social media content. Natural language processing may include performing a semantic analysis. For example, a user may post social media content that reads, “I need a new computer.” In this case, the user expresses a clear need for a new product, e.g., a computer. The ERP server 130 may extract this need from the social media content using natural language processing.

In some embodiments, the language of the social media content may be detected prior to natural language processing. Acts performed by the at least one ERP server 130 subsequent to the language detection may depend on the result of the language detection. For example, the natural language processing of the social media content may use a different analysis based on the language. In some embodiments, the social media content may be translated to a language that is common with the language of business profiles associated with a plurality of businesses. Alternatively, the language of the business profiles may be translated to the language of the social media content. By assuring a common language is used, the social media content may be compared to the information in one or more business profiles.

In some embodiments, the geolocation of the user of the social media platform may be determined by at least one ERP server 130. Geolocation refers to the user's physical location in the world, not a logical location such as the IP address or subnet of the user's computer (though the IP address or subnet of the user may be used to determine the geolocation of the user). A user's geolocation may be determined in any suitable way. In some embodiments, the geolocation of the user's home or place of business may be retrieved from the user's social media platform profile. In other embodiments, the geolocation of the user when a post to a social network is created may be retrieved from the post itself. For example, some social media platforms, such as Facebook and Twitter, allow the user's geolocation to be posted along with the social media content based on the global positioning system (GPS) location determined by the user's computing device. Alternatively, the user may have specified geolocation information in the social media content being analyzed. For example, the content may mention a city, state, or other geolocation information. Accordingly, geolocation information, and any other suitable information, may be determined by analyzing the content of a user's social media posts.

In some embodiments, the at least one ERP server 130 may also determine the sentiment associated with a user's social media post. For example, a social media post may express disappointment or anger with a product or service. The sentiment of the user may be used by the at least one ERP server to determine whether the user is expressing a need. For example, if a first exemplary social media post reads, “I hate my computer—it is so slow,” the user is clearly expressing negative sentiments about his computer. Accordingly, it may be concluded that there is a high probability that the user has a need for a new computer and/or a computer repair service. Contrasting the first exemplary social media post with a second exemplary social media post reading, “I love my computer—my old one was so slow,” it can be seen that many of the same words are used (e.g., “my computer”, “slow”) but the sentiment expressed is very different. The second exemplary social media post expresses no need for a new computer or computer repair service. The two above examples demonstrate use of semantic analysis and determining the sentiment of social media content when determining whether a user is expressing a need.

As described above, some social media posts may express a direct need, using words like “need” and “want,” whereas other posts may imply a need by the sentiment of the tweet, for example, by expressing a like or dislike of a product and/or service. Generally, a need of a user may be determined by taking into account all of the words used in the social media content and determining how they relate to one another. The ERP server 130 determines words expressing a need, words describing a product and/or service and words expressing a sentiment of a user to extract whether the social media content is expressing a need and determine what that need is.

In some embodiments, the at least one ERP server 130 may receive business profile information from each of the businesses using the ERP service. The business profile information may be received when the business registers for the ERP service, though the information may be updated at any time. The business profile information may include key words related to the types of service and products that the business provides, information about the service area or delivery area for which the business provides service for customers, and any other suitable information about the business that may be used by the ERP server 130 to determine whether a business can satisfy a need of a social media platform user.

In some embodiments, the at least one ERP server 130 may determine at least one relevance value that may be compared to at least one threshold value to determine the relevance of the user's need to each business. Some embodiments may determine a geolocation relevance based on the location information specified in the business's profile and the location information attained from the user's social media content. The geolocation relevance may be, for example, a measure of how well the determined user's location corresponds to the service area of the business. Alternatively, or additionally, a semantic relevance may be calculated based on the comparison of the determined need of the user and the business profile. The semantic relevance may be, for example, a measure of how well the user's need matches the products and services offered by the business. Embodiments are not limited to any particular number or type of relevance measures. For example, an overall relevance value may be determined based on the relevance value of the geolocation relevance and the semantic relevance.

In some embodiments, in response to determining that a social media platform user may be a potential customer for a business, the business may be notified and provided with information about the user. The business may be notified in any suitable way. Some embodiments store the notification and user information in database 132 in a manner that is accessible by a business via the ERP service. For example, a human 152 associated with the business may use a computer 162 to connect to the ERP server 130 via network 140. The notification and/or information about the potential customer may be accessed by the human 152 using the same ERP SaaS interface that is used to access other aspects of the ERP software. In other embodiments, a human 158 associated with the business may be using a mobile device 168, such as a mobile telephone, tablet, or personal digital assistant (PDA). In some embodiments, the mobile device may be executing a specialized ERP application that give the human 158 access to the ERP service in the cloud. The at least one ERP server may use push notifications to notify the human 158 in real time when a potential customer is identified. In other embodiments, the human 158 may be notified using an SMS message or email message received by mobile device 168.

In some embodiments, ERP server 130 services a plurality of businesses. Each business may have at least one human 152, 154, 156, 158 that accesses the ERP service via a computing device 162,164, 166, 168, respectively. Any suitable computing device may be used. For example, computing devices 162,164, 166, 168 may be a desktop computer, a laptop computer, a tablet computer, a PDA, or a mobile telephone.

In some embodiments, computing device 164 may notify human 154 of the potential customer in real time by presenting information about the potential customer on a display device of the computing device. The human 154 may respond to the notification by writing and sending a personalized message to the potential customer using computing device 164. In some embodiments, the personalized message may be sent directly to the social media platform server 110 without sending the message to the ERP server 130. In other embodiments, the personalized message may be sent to the ERP server 130, which then relays the message to the social media platform server 110 for delivery to the potential customer. By sending the message to the ERP server 130, information about the message may be stored in database 132 in association with the CRM portion of the ERP software. This may allow the tracking of the potential customer lead and keep a record of communications with the potential customer for the business's records.

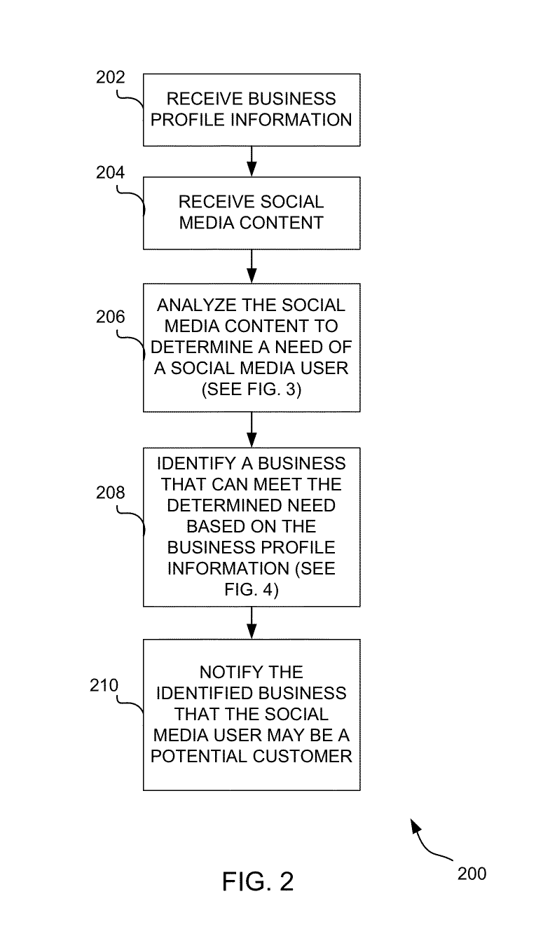

FIG. 2 illustrates a process 200 for identifying potential customers for one or more businesses according to some embodiments. In some embodiments, the process 200 may be performed entirely by ERP server 130 and database 132. In other embodiments, portions of process 200 may be performed by the social media platform server 110, database 112, mobile device 168 and/or a computing device 162 associated with a business.

At act 202, the ERP server 130 receives business profile information from at least one business. The ERP server 130 performs ERP tasks for a plurality of business and each business that indicates that it wishes to receive real time notifications about potential customer must have a business profile. The business profile may comprise any suitable information about the business. For example, the profile may include keywords related to the products and/or services that the business offers. The profile may also include information describing the geolocation where the business is looking for new customers. The physical location where the business is seeking new customers may correspond to the entire area that a business services or it may correspond to a sub-area within a service area where a business is trying to grow its customer base.

The business profile information may be received in any suitable way. The business profile information may be received during a business registration process that is implemented when a business first subscribes to the ERP service. In some embodiments, the business may specify information for the business profile using a computing device that accesses the ERP SaaS via a network. Alternatively, the business may communicate with the ERP service provider via email or telephone to create or update its business profile. Embodiments are not limited to any particular method of receiving business profile information.

At act 204, the ERP server 130 receives social media content from at least one social media platform server 110. In some embodiments, the ERP server 130 may receive and monitor social media content from a plurality of social media platforms. Any suitable social media platform may be monitored. By way of example, the social media platform may be Twitter, Facebook, LinkedIn and/or Google+. In alternative embodiments, websites that enable users to communicate social media content to others apart from any defined social network may be analyzed. For example, websites that host user generated content, such as Craigslist, Yelp and/or Reddit may be monitored.

The social media content may be received by ERP server 130 via a network interface that receives information from network 120. In some embodiments, the social media content is received in response to a request sent to social media platform server 110 from the ERP server 130. In some embodiments, the social media content is streamed from the social media platform server 110 as users of the social media platform create new social media content. In alternative embodiments, the ERP server 130 and the social media platform server may be implemented on the same physical server, in which case the social media content is received by an ERP software module from a social media platform software module.

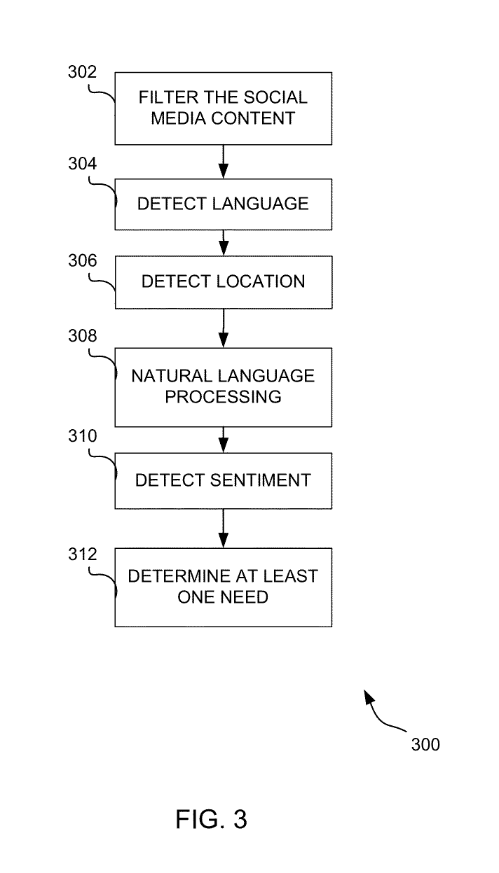

At act 206, the ERP server 130 analyzes the social media content to determine at least one need of the social media platform user. The analysis may be done in any suitable way. For example, natural language processing may be used to determine the needs of the user. An exemplary embodiment describing how the analysis is performed is described in more detail in connection with FIG. 3 below.

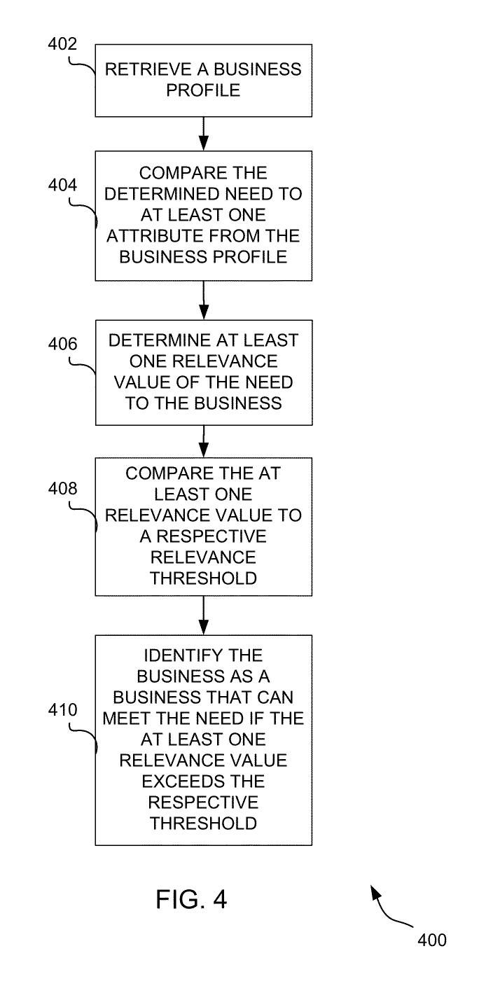

At act 208, the ERP server 130 identifies a business, from the plurality of businesses that the ERP server 130 services, that can meet the at least one determined need of the social media user. In some embodiments, for each portion of social media content, such as a post to a social network, where a need is determined to exist based on act 206, the determined need is compared to the information contained in each business profile for each of the businesses that the ERP server 130 services to determine which, if any of the businesses can meet the user's need. An exemplary embodiment describing how the business identification process may be performed is described in more detail in connection with FIG. 4 below.

At act 210, ERP server 130 may notify the identified business that the social media user may be a potential customer. The notification may be done in any suitable way. In some embodiments, the notification may be sent automatically in electronic form. For example, a notification may be stored in database 132, which may be accessible to the business via network 140. The notification may appear in the ERP SaaS graphical user interface on the display device of a business's computer when a business user is logged in to the ERP service. In other embodiments, the business may be notified by email or SMS message that a potential customer was identified. Alternatively, a mobile device 168 of a business may be sent a push notification by the ERP server 130 to notify a human 158 associated with the business that a potential customer was identified.

Any suitable notification may be sent. In some embodiments, the notification may be a message that simply notifies the business that a potential customer was identified and ask the business to log into the ERP service to retrieve further information. In other embodiments, the notification may identify the user, the determined need, the text of the social media content that expressed the need and/or a hyperlink to the social media platform or the ERP service that leads to a webpage that allows the business to send a personalized message to the potential customer.

FIG. 3 illustrates an exemplary embodiment of a process for analyzing a user's social media content to determine at least one need of the user. In some embodiments, the process 200 may be performed entirely by ERP server 130 and database 132. In other embodiments, portions of process 200 may be performed by the social media platform server 110 and database 112.

At act 302, the social media content is filtered. The total amount of social media content available from the social media platform server 110 may be too great to analyze each social media post by every social media user. Accordingly, the social media content may be filtered, prior to analysis, to discard social media content that is unlikely to lead to the identification of a potential customer. For example, social media content containing specified keywords, such as swear words, may be filtered out. In some embodiments, certain social media users may be filtered out. Other embodiments may only allow social media content through the filter if it contains certain words that are indicative of expressing a need. For example, social media content containing the words/phrases “need”, “want”, “need a new”, “need some”, “want a new” and “want more” are likely to indicate that the user has a need.

The act of filtering 302 may be done by any suitable computing device. In some embodiments, the filtering may be performed by the social media platform server 110 prior to transmitting the social media content over network 120 to the ERP server 130. In other embodiments, the filtering may be performed on the ERP server 130. In an alternative embodiment, filtering may be done on both the social media platform server 110 and the ERP server 130.

At act 304, the language of a particular portion of the social media content may be detected. Language detection may be performed in any suitable way, as is known in the art.

At act 306, the location of the social media user that created the social media content may be detected. The location that is relevant for most embodiments is the geolocation, i.e., the physical location of the user in the world. For example, the geolocation may comprise the city and state where the user lives and/or works. The geolocation may also be the specific physical location where the user was when the social media content was generated. For example, if the social media content is a tweet posted by the user on Twitter via the user's mobile phone, the geolocation may be the physical location of the user's mobile phone when the tweet was transmitted to Twitter.

A user's geolocation may be determined in any suitable way. In some embodiments, the geolocation of the user's home or place of business may be retrieved from the user's social media platform profile, which may be stored in database 112. In other embodiments, the geolocation of the user when a post to a social network is created may be retrieved from the post itself. For example, some social media platforms, such as Facebook and Twitter, allow the user's geolocation to be posted along with the social media content based on the global positioning system (GPS) location determined by the user's computing device. Alternatively, the user may have specified geolocation information in the social media content being analyzed. For example, the content may mention a city, state, or other geolocation information.

At act 308, natural language processing is performed to analyze the social media content. By utilizing natural language processing, a need of a user may be accurately determined. Natural language processing allows the human sentiment of the social media content to be converted into a more logical, formalized format that the ERP server 130 may then interpret as expressing a need. This process allows a deeper understanding of the semantics of the social media content when compared to a simpler analysis such as mere keyword extraction. In some embodiments, the results of the natural language processing may be at least one action and at least one noun extracted from the social media content.

At act 310, the sentiment of the social media content may be detected. The sentiment of the user may be used by the at least one ERP server 130 to determine whether the user is expressing a need. For example, a negative sentiment associated with a product or service mentioned in the social media content may indicate the need to purchase a new replacement product or service. In some embodiments, the sentiment of social media content may be detected from content that is not standard language, such as emoticons. For example, the character string “:-)” may indicate a positive sentiment, whereas the character string “:-(” may indicate a negative sentiment. Other content, including abbreviations, might similarly be converted to words or other symbols that can support processing to identify a need.

At act 312, the at least one need of the user is determined. The need may be determined in any suitable way. For example, the ERP server 130 may use the detected sentiment, and the results of the natural language processing, to determine if there is a need and what the need is. In some embodiments, if the natural language processing indicates that the user used a verb expressing desire or need for an object and a negative sentiment was detected, it may be determined that there the user has expressed a need. For example, if the natural language processing determines that the user used the verb “hate” in conjunction with the noun “computer”, along with an emoticon expressing negative sentiment, then ERP server 130 may determine that the user has expressed a need for a new computer and/or a computer repair service.

FIG. 4 illustrates a process 400 for identifying a business that can meet the determined need of the user according to some embodiments. In some embodiments, the process 400 may be performed entirely by ERP server 130 and database 132. In other embodiments, portions of process 200 may be performed by the social media platform server 110, database 112, mobile device 168 and/or a computing device 162 associated with a business.

In some embodiments, the process 400 is repeated, for each piece of the social media content that is identified as expressing a need and for each business that uses the ERP service. Though, in some embodiments, each identified piece of social media content may be compared with business profiles only until a business using the ERP service that can fulfill the identified need is identified. If the process 400 is repeated to identify multiple businesses that can meet the need, a ranking algorithm to identify a business that can best meet the need may be applied or any other suitable criteria may be used to select a business to be notified of the prospective customer. Alternatively, if multiple businesses are identified, the prospective customer may be identified to some or all of those multiple businesses.

At act 402, at least a portion of a business profile is accessed by ERP server 130. In some embodiments, the business profile may be retrieved from database 132. However, the business profile of each business may be stored in any suitable location.

At act 404, the user's need determined from the social media content is compared to at least one attribute from the business profile. In some embodiments, this comparison may comprise comparing keywords from the business profile with the determined need. The ERP server 130 may also compare the geolocation of the user with location information stored in the business profile.

Based on the at least one comparison, at least one relevance value is determined at act 406. Any suitable relevance value may be used. In some embodiments, the relevance value may be a semantic relevance, which expresses the relevance of the determined need to the products and services offered by the business, as expressed in the business profile. Alternatively, or additionally, the relevance value may be a geolocation relevance, which expresses the relevance of the user's geolocation to the service area of the business as expressed in the business profile.

At act 408, the at least one relevance value is compared to a respective relevance threshold. The relevance threshold may be stored, for example, in the business profile. In some embodiments the relevance threshold may be determined by the business. In other embodiments, the at least one relevance threshold may be determined by the ERP service provider. The relevance threshold may be tuned so that a desired frequency of potential customers is received from the ERP service. For example, if the business is being notified too frequently of potential customers, the relevance threshold may be raised thereby reducing the quantity of notifications and increasing the quality of each notification.

At act 410, a business is identified as a business that can meet the determined need of the user when the at least one relevance threshold exceeds the respective relevance threshold. In some embodiments, if more than one relevance value is used, the business may be identified as a business that can meet the user's need if all the relevance values exceed each respective relevance threshold.

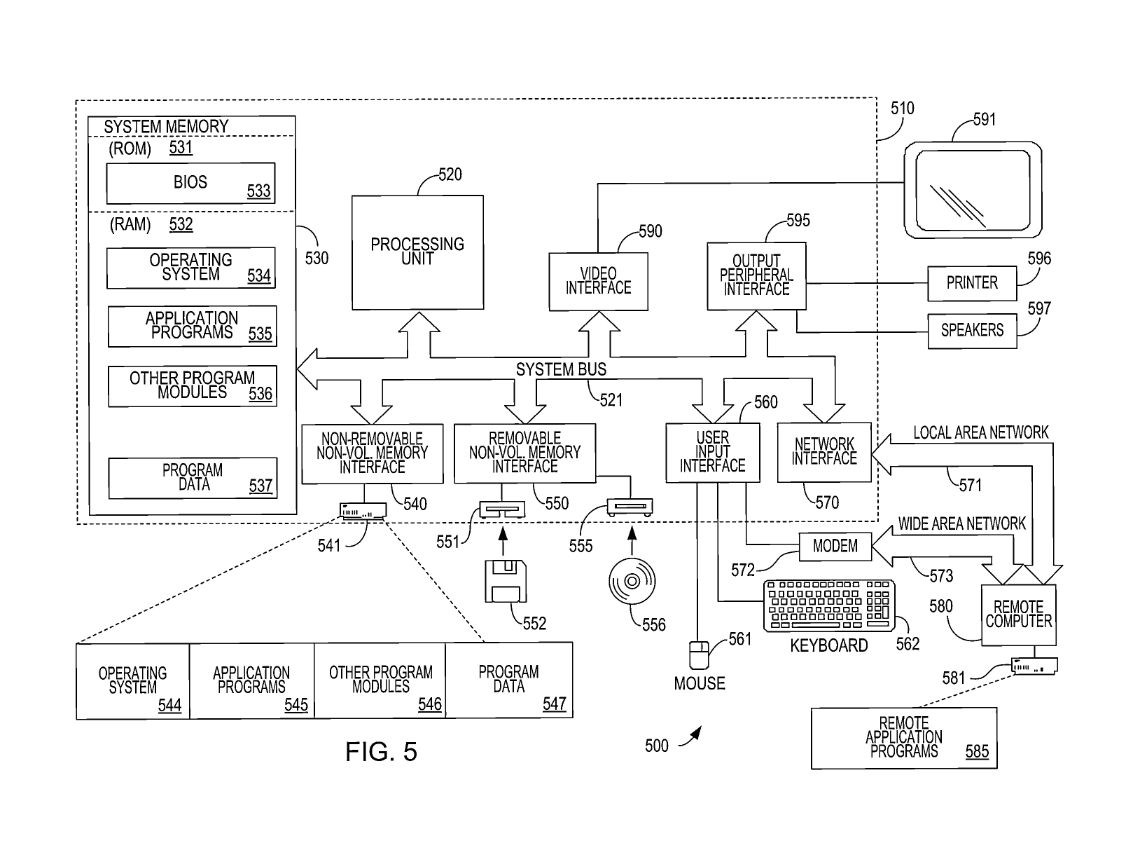

FIG. 5 illustrates an example of a suitable computing device 500 on which aspects of the invention may be implemented. For example, social media platform server 110, ERP server 130, and/or computing devices 162, 164, 166 and 168 may include all or portions of computing device 500. The computing device 500 is only one example of a suitable computing device and is not intended to suggest any limitation as to the scope of use or functionality of the invention. Neither should the computing device 500 be interpreted as having any dependency or requirement relating to any one or combination of components illustrated in the exemplary operating device 500.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 5, an exemplary system for implementing the invention includes a general purpose computing device in the form of a computer 510. Components of computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EERPOM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 510. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5, provide storage of computer readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. In addition to the monitor, computers may also include other peripheral output devices such as speakers 597 and printer 596, which may be connected through an output peripheral interface 595.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 5 illustrates remote application programs 585 as residing on memory device 581. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

For example, some of the described embodiments were described with reference to tweets on Twitter. It should be understood that embodiments are not limited to tweets. Any social media content may be used. Moreover, embodiments are not limited to Twitter. Any social media platform may be used.

It should also be understood that, for simplicity, a single server is illustrated in FIG. 1 for both the social media platform server 110 and ERP server 130. However, embodiments may use a plurality of servers for the same purposes. For example, in some embodiments, the ERP server 130 that analyzes social media content and identifies potential customers may be implemented on a separate server from one or more servers that perform other ERP functions.

Embodiments have been described with reference to social media content stored in databases. However, embodiments are not limited to data stored on static storage devices. The techniques described above may also apply to streaming information.

In some embodiments, natural language processing may not be used. Instead, for example, the social media content may be analyzed using keyword matching.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of operating at least one computing device to identify potential customers, the method comprising:
analyzing social media content to determine a need of a social media user;
identifying a business of a plurality of businesses that can meet the determined need; and
notifying the identified business that the social media user may be a potential customer.

2. The method of claim 1, wherein notifying the identified business comprises transmitting a notification to a mobile device associated with the business.

3. The method of claim 1, further comprising:
filtering the social media content prior to analyzing the social media content.

4. The method of claim 1, wherein analyzing the social media content comprises performing natural language processing.

5. The method of claim 1, wherein analyzing the social media content comprises determining a sentiment of the social media content.

6. The method of claim 1, wherein the need is determined based on a single post on a social media platform.

7. The method of claim 1, wherein analyzing the social media content is done in real-time.

8. The method of claim 1, further comprising:
receiving profile information for the plurality of businesses, wherein the profile information comprises keywords associated with the products and/or services provided by each of the plurality of businesses.

9. The method of claim 1, further comprising:
receiving, from the identified business, a message directed to the social media user.

10. The method of claim 9, further comprising:
presenting information about the social media user on a display device;
wherein the message directed to the social media user was created by a human in response to the information about the social media user presented on the display device.

11. The method of claim 1, wherein identifying a business of the plurality of businesses that can meet the determined need comprises:
determining a relevance value associated with the relevance of each of the plurality of businesses to the determined need; and
comparing the relevance value to a relevance threshold;
identifying a business as being able to meet the determined need when the relevance value is greater than or equal to the relevance threshold.

12. At least one computing device for identifying potential customers, the computing device comprising:
at least one network interface adapted to receive social media content from a social media platform server;
at least one storage device adapted to store information about a plurality of businesses;
at least one processor adapted to:
analyze the social media content to determine a need of a social media user;
identify a first business of the plurality of businesses that can meet the determined need; and
wherein the at least one network interface is further adapted to notify the identified business that the social media user may be a potential customer.

13. The at least one computing device of claim 12, wherein:
the information about a plurality of businesses comprises business location information describing a service area of at least the first business;
analyzing the social media content comprises determining geolocation information describing the physical location of the social media user; and
identifying that the first business can meet the determined need comprises determining that the physical location of the social media user is within the service area of the first business.

14. The at least one computing device of claim 13, wherein determining that the physical location of the social media user is within the service area of the first business comprises:
determining a geolocation relevance associated with the geolocation information; and
comparing the geolocation relevance to a geolocation threshold determined based on the service area of the first business.

15. At least one non-transitory computer-readable storage medium comprising computer-executable instructions that, when executed, perform a method for identifying potential customers, the method comprising:
analyzing social media content to determine a need of a social media user;
identifying a business of a plurality of businesses that can meet the determined need; and
notifying the identified business that the social media user may be a potential customer.

16. The at least one non-transitory computer-readable storage medium of claim 15, wherein the computer executable instructions comprise enterprise resource planning software.

17. The at least one non-transitory computer-readable storage medium of claim 15, wherein analyzing the social media content comprises:
detecting a language of the social media content; and
performing natural language processing on the social media content based on the detected language.

18. The at least one non-transitory computer-readable storage medium of claim 17, wherein analyzing the social media content comprises detecting a sentiment of the social media content.

19. The at least one non-transitory computer-readable storage medium of claim 15, wherein the method further comprises:
receiving profile information for the plurality of businesses, wherein the profile information comprises keywords associated with the products and/or services provided by each of the plurality of businesses.

20. The at least one non-transitory computer-readable storage medium of claim 19, wherein the method further comprises:
presenting information about the social media user on a display device; and
receiving, from the identified business, a message directed to the social media user created by a human in response to the information about the social media user presented on the display device.
